(19) United States
(12) Patent Application Publication
(10) Pub. No.: US 2003/0138620 A1
(43) Pub. Date: Jul. 24, 2003

(54) Flexible magnetic layer based rubber mat

(76) Inventor: Jose E. Fonseca, Eugene, OR (US)

Correspondence Address: Richard C. Litman, LITMAN LAW OFFICES, LTD., P.O. Box 15035, Arlington, VA, 22215, US

(21) Appl. No.: 10/051,167

(22) Filed: Jan. 22, 2002

(51) Int. Cl. B32B 7/12

(52) U.S. Cl. 428/317.1; 428/900; 428/308.4

(57) ABSTRACT

A flexible magnetic layer based rubberized mat of extensive area for temporarily protecting the metal roof or a metal floor of a vehicle carrying luggage and the like.

### BACKGROUND OF THE INVENTION

1. Field of the Invention

The present invention relates generally to mats. More specifically, the invention is a flexible mat for protecting a metal surface from damage when heavy materials are placed on it. The mat has a flexible magnetic layer under a rubberized layer.

2. Description of the Related Art

The related art of interest describes various mats but none discloses the present invention. There is a need for a durable, flexible, magnetic and rubberized mat suitable for protecting metal surfaces when objects are laid on or in them such as a station wagon or SUV with a roof rack and a metal roof. Or, the mat could be used on a metal floor. The mat can be readily rolled up for portage or for storage. The related art will be discussed in the order of perceived relevance to the present invention.

U.S. Pat. No. 5,312,145 issued on May 17, 1994, to Robert A. McNeil describes a magnetized and padded foldable panel for protecting the sides of a vehicle comprising a first layer of a thin flexible foamed polymer sheet containing magnetic particles, a second layer of a thick polyurethane foam sheet, and a cover layer of polyamide fabric which is cross-stitched for folding. The device is distinguishable for requiring a magnetized foam layer, a plastic foam layer and a fabric cover.

U.S. Pat. No. 5,050,925 issued on Sep. 24, 1991, to Larry E. Brown describes a clear polyvinyl chloride cover with magnets to protect the sides of a parked vehicle. The cover is distinguishable for requiring a rigid plastic sheet with individual magnets.

U.S. Pat. No. 5,275,460 issued on Jan. 4, 1994, to Menahem Kraus describes a protective cover for a motor vehicle comprising a polyethylene sheet having a plurality of magnet strips placed strategically on the sheet to cooperate when folding. The cover is distinguishable for requiring individual magnet strips in a definite pattern to aid in folding.

U.S. Pat. No. 5,806,909 issued on Sep. 15, 1998, to Ronald D. Wise describes a removable truck bed liner comprising a closed cell polyethylene foam alone or laminated under a layer of carpeting. The separate panels can be attached to the truck bed by magnets, inter alia materials such as screws, rivets, snaps, and hook and loop fasteners. The truck bed liner is distinguishable for its required foam and carpet structure.

U.S. Pat. No. 6,203,095 B1 issued on Mar. 20, 2001, to Del R. Peterson describes a body protector assembly for a vehicle comprising a fabric cover having a series of horizontal parallel plastic strips underneath on the sides of the vehicle and a metal bottom plate connected by magnetic disks to the cover. The doors can have separate panels with plastic strips and outlined by magnetic disks. The assembly is distinguishable for its fabric cover with plastic strips, a metal bottom plate, and magnetic disks.

U.S. Pat. No. 3,020,562 issued on Feb. 13, 1962, and U.S. Pat. No. 3,034,140 issued on May 15, 1962, to John A. Reynolds describes a rubber bath tub mat with an array of embedded magnetic disks which can be stored on the hidden side of the bath tub. The mat is distinguishable for its embedded magnet disks.

U.S. Design Pat. No. 312,237 issued on Nov. 30, 1999, to Gary J. Gerk describes an ornamental protective magnetic drop covering for painters comprising a rectangular sheet with an array of magnetic disks and an ornamental spiked decoration at two opposite corners. The magnetic drop covering is distinguishable for its array of magnetic disks on a bottom surface.

The following patents all relate to detachable covers to attach to the sides of a vehicle by various means.

U.S. Design Pat. No. 312,237 issued on Nov. 20, 1990, to John R. Avery describes an ornamental detachable protective pad cover comprising a rectangular pad with two hook and loop fastener end pads on opposite sides of the pad, a pair of assumed rectangular magnetic pieces on each long edge, and a ring on a strap centered on one long edge. The pad cover is distinguishable for its separated magnetic pieces and other attachment elements such as the hook and loop fasteners and ring.

U.S. Pat. No. 4,810,015 issued on Mar. 7, 1989, to Robert A. McNeil describes a rectangular body side protector comprising a fabric covered foam rubber pad having a pair of bar magnets on the top and bottom edges and a pair of elastic loops on each end for attachment to the wheel wells. The device is distinguishable for its addition of only two pairs of separated magnets and the requirement for end loops.

U.S. Pat. No. 4,896,911 issued on Jan. 30, 1990, to Vincent M. Duke describes an automobile side protector device comprising an elongated flexible sheet form for each side of the automobile having a front and rear flap surrounding a cutaway center portion having a metal hook and a pair of magnets. The magnets are embedded between an outer vinyl layer and a cotton or felt enclosure. The device is distinguishable for its unique structure with a minimum of magnets.

U.S. Pat. No. 5,072,979 issued on Dec. 17, 1991, to Randolph M. Swinton describes a protective rectangular panel for a vehicle comprising three panels with hook and loop fastener strips on a portion of its upper and lower edges along with two embedded bar magnets on each panel along its upper and lower edges. The panel is distinguishable for requiring hook and loop fasteners as well as a limited number of magnets.

U.S. Pat. No. 5,129,695 issued on Jul. 14, 1992, to Charles E. Norman, II describes a flexible rectangular vehicle door protector device having four flexible magnetic tapes at each corner embedded in a fabric sheet of corduroy, nylon or canvas on the inside surface, and a batting or foam rubber under a calendared plastic sheet on the outside. The device has a flap on the bottom edge connected to a first strap connectible to a second strap on the top edge for hooking over the door and fastened together by hook and loop patches on the ends of the straps. The device is distinguishable for its required flap and strap structure.

U.S. Pat. No. 5,320,392 issued on Jun. 14, 1994, to David M. Hart describes a rectangular removably attachable vehicle door protection pad having a fabric front surface and a plastic back surface enclosing a magnetic strip. The pad ends have handle holes at each end, wherein one handle has a security cable attached to a suction cup for attaching to the window on the inside. The pad is distinguishable for its embedded magnetic strip and the requirement for a security cable.

U.S. Pat. No. 5,549,938 issued on Aug. 27, 1996, to Gregg G. Nesbitt describes a removable camouflage for hunting and military vehicles comprising a flexible magnetic base laminated to a vinyl sheet having a camouflage pattern. The magnetic base layer is made from iron filings or other magnetic particles in a rubber or vinyl matrix. The camouflage panel is distinguishable for its iron filing containing vinyl layer.

U.S. Pat. No. 5,799,992 issued on Sep. 1, 1998, to Kimberly Kojima describes a protective device for the sides of a vehicle comprising a rectangular sheet of rubberized fabric with or without a backing layer of terry cloth, canvas or denim which is hung by a pair of loops to a foldable rod by a pair of loops. The rod has a pair of hanger hooks which fit over the windows. Four magnets or weights can be attached to the bottom edge of the sheet. The device is distinguishable for its requirement for a foldable rod, loops and hanger hooks.

None of the above inventions and patents, taken either singularly or in combination, is seen to describe the instant invention as claimed. Thus, a flexible magnetic layer based rubber mat solving the aforementioned problems is desired.

### SUMMARY OF THE INVENTION

The present invention is a flexible magnetic mat comprising a top layer of rubberized material adhered to a bottom layer of a flexible magnetic layer. The mat can be utilized to protect the metal surface of a roof or an interior floor of a vehicle when any heavy article is laid on top of the mat. If luggage is placed on top of a vehicle and strapped down, speeds up to 70 mph would not dislodge the mat. The mat can have various shapes such as rectangular, circular and the like and can be readily rolled up for storage or portage. The mat is simple in structure and economical in cost to produce.

Accordingly, it is a principal object of the invention to provide a magnetic mat.

It is another object of the invention to provide a magnetic mat having a flexible top layer of a rubberized composition.

It is a further object of the invention to provide a flexible magnetic layer attached to a top layer of a rubberized composition.

Still another object of the invention is to provide a flexible magnetic mat suitable for placement under objects on a metal surface.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a flexible magnetic layer based rubber mat utilized on the roof of a vehicle under luggage according to the present invention.

FIG. 2 is a plan view of a rectangular mat.

FIG. 3 is a side elevational view of the FIG. 2 mat.

Similar reference characters denote corresponding features consistently throughout the attached drawings.

### DETAILED DESCRIPTION OF THE PREFERRED EMBODIMENT

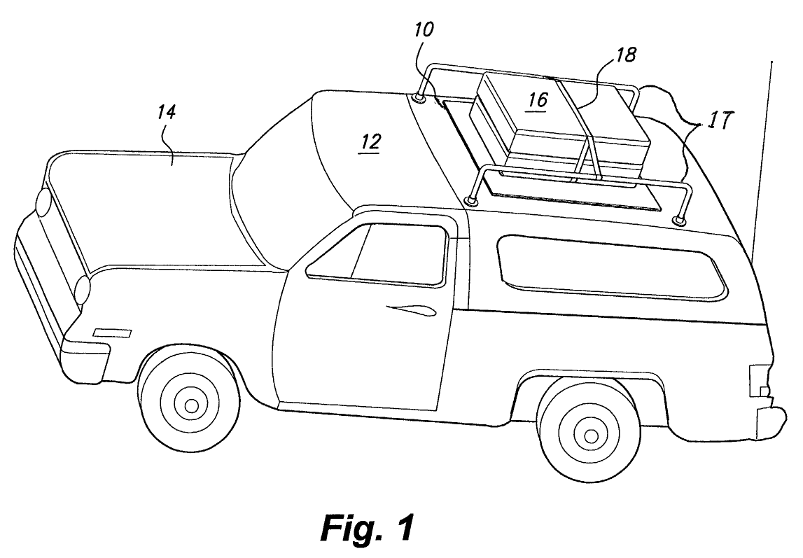

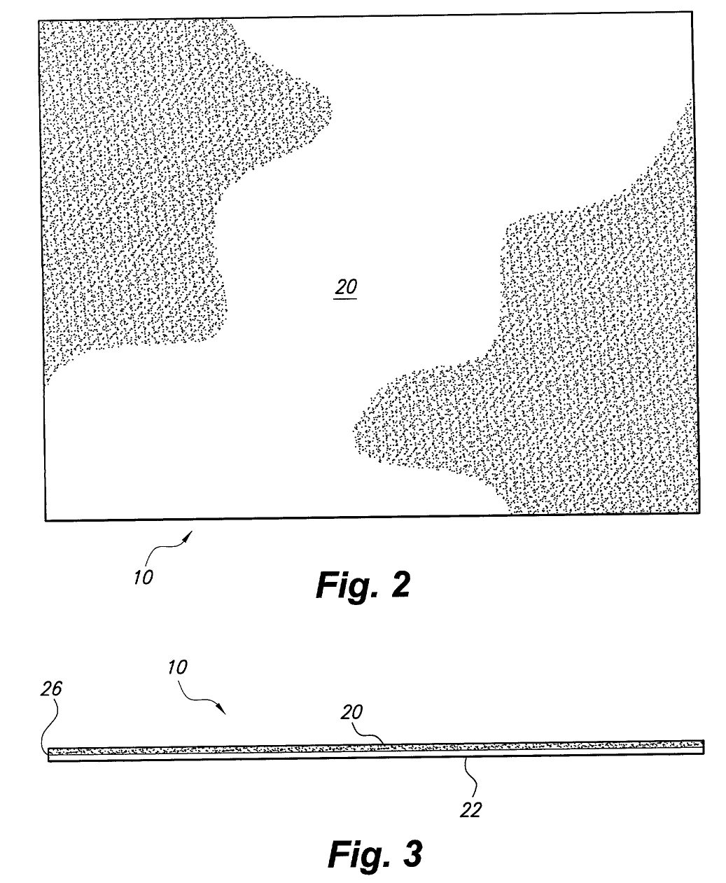

In FIG. 1, a rectangular mat 10 of the present invention is illustrated protecting the roof 12 of a sport utility vehicle (SUV) 14 from abrasion from the trunk 16 held immobile between a roof rack 17 by a strap 18. FIGS. 2 and 3 illustrate a top view and a side view of the rectangular mat 10. The top layer 20 is preferably made of rubberized composition such as 0.25 inch thick neoprene used for scuba diving or rubberized plastic, and adhesively bound to the 30 mm thick bottom layer 22 of a flexible magnetic layer 24 by any suitable conventional adhesive 26. Other suitable flexible materials for the top layer 20 may include rubber, styrofoam, vinyl, polyethylene, and other plastic materials. It will be understood that the above mentioned thickness dimensions are merely preferred dimensions, and that the top layer 20 may vary in thickness between 1/16″ and 1″, while the bottom layer 22 may vary in thickness between 15 mm and 60 mm. The flexible mat 10 can be rolled up without damage for portage or storage. The mat 10 has been shown to be immovable even when laid on a vehicle roof travelling at highway speeds.

The method of making the mat 10 can be performed at home by having a layer of neoprene for the top layer 20 and the bottom layer 22 of a flexible magnetic layer patterned to the same size and shape, be it rectangular, round, triangular, oval, and the like. The adhesive will be applied to one or both layers and rolled evenly by a roller tool such as a painter's roller to eliminate any bubbles. The layers are joined and a clean roller is utilized to remove any air bubbles. The mat 10 is allowed to dry out and the adhesive to cure to form a secure unified bond of the layers 20 and 22.

It will be understood that the mat 10 of the present invention is not limited to two layers, and may comprise the magnetic layer 24 sandwiched between identical layers of flexible material of the same composition as top layer 20 described above.

It is to be understood that the present invention is not limited to the embodiment described above, but encompasses any and all embodiments within the scope of the following claims.

I claim:

1. A flexible magnetic layer based rubberized mat comprising:
a layer of a flexible magnetic composition;
a layer of an adhesive composition on said magnetic composition; and
a layer of a rubberized composition on said adhesive composition;
whereby the layers of the magnetic composition, the adhesive composition and the rubberized composition form a unitary flexible mat for use on metal surfaces.

2. The mat according to claim 1, wherein the layers of the magnetic composition, adhesive and rubberized composition are coextensive in area.

3. The mat according to claim 1, wherein the rubberized composition is neoprene rubber.

4. The mat according to claim 1, wherein the rubberized composition is rubberized plastic.
